(19) United States
(12) Patent Application Publication
(10) Pub. No.: US 2026/0188902 A1
(43) Pub. Date: Jul. 2, 2026

(54) ANTENNA AND ELECTRONIC DEVICE

(71) Applicant: Lenovo (Beijing) Limited, Beijing (CN)

(72) Inventors: Kejia LIN, Beijing (CN); Lei WU, Beijing (CN); Bing LI, Beijing (CN)

(21) Appl. No.: 19/413,415

(22) Filed: Dec. 9, 2025

(30) Foreign Application Priority Data
Dec. 26, 2024 (CN) 202411942988.3

(51) Int. Cl. H01Q 5/307; H01Q 1/38

(52) U.S. Cl. CPC H01Q 5/307; H01Q 1/38

(57) ABSTRACT

An antenna includes a dielectric substrate having a first surface and a second surface opposite to each other, a first conductive plate arranged at the first surface, a second conductive plate arranged at the second surface, and a plurality of metal members sequentially arranged adjacently one after another at the dielectric substrate. A distance between two adjacent metal members among the plurality of metal members is greater than a preset distance, and a projection of an overall shape of the plurality of metal members on the dielectric substrate has an opening.

### CROSS-REFERENCE TO RELATED APPLICATION

This application claims priority to Chinese Patent Application No. 202411942988.3, filed on Dec. 26, 2024, the entire content of which is incorporated herein by reference.

### TECHNICAL FIELD

The present disclosure generally relates to the communication technology field and, more particularly, to an antenna and an electronic device.

### BACKGROUND

Currently, to meet users'demands for more integrated functions in electronic devices, electronic devices need to integrate more electronic components within a limited space, resulting in increasingly smaller antenna installation space. Furthermore, in pursuit of a more “high-end” metallic feel and a slimmer body, electronic devices often use pure metal casings, which further compress the antenna installation space. This smaller installation space leads to a shorter distance between the antenna and the metal members of the electronic device, affecting the antenna's communication performance.

### SUMMARY

In accordance with the disclosure, there is provided an antenna including a dielectric substrate having a first surface and a second surface opposite to each other, a first conductive plate arranged at the first surface, a second conductive plate arranged at the second surface, and a plurality of metal members sequentially arranged adjacently one after another at the dielectric substrate. A distance between two adjacent metal members among the plurality of metal members is greater than a preset distance, and a projection of an overall shape of the plurality of metal members on the dielectric substrate has an opening.

Also in accordance with the disclosure, there is provided an electronic device including a metal back cover, a metal back plate of a screen, and an antenna disposed between the metal back cover and the metal back plate of the screen. The antenna includes a dielectric substrate having a first surface and a second surface opposite to each other, a first conductive plate arranged at the first surface, a second conductive plate arranged at the second surface, and a plurality of metal members sequentially arranged adjacently one after another at the dielectric substrate. A distance between two adjacent metal members among the plurality of metal members is greater than a preset distance, and a projection of an overall shape of the plurality of metal members on the dielectric substrate has an opening.

### BRIEF DESCRIPTION OF THE DRAWINGS

The above and other objects, features, and advantages of this disclosure will become clearer from the following description of embodiments of the present disclosure with reference to the accompanying drawings.

FIG. 1 is a schematic exploded structural view of an antenna consistent with the present disclosure.

FIG. 2 is a schematic diagram showing principles of electromagnetic mirroring consistent with the present disclosure.

FIG. 3 schematically shows a projected pattern of a plurality of metal members on a dielectric substrate consistent with the present disclosure.

FIG. 4 schematically shows another projected pattern of a plurality of metal members on a dielectric substrate consistent with the present disclosure.

FIG. 5 schematically shows another projected pattern of a plurality of metal members on a dielectric substrate consistent with the present disclosure.

FIG. 6 schematically shows another projected pattern of a plurality of metal members on a dielectric substrate consistent with the present disclosure.

FIG. 7 schematically shows another projected pattern of a plurality of metal members on a dielectric substrate consistent with the present disclosure.

FIG. 8 is a schematic external structural view of an antenna consistent with the present disclosure.

FIG. 9 is a schematic structural diagram of an electronic device consistent with the present disclosure.

FIG. 10 is a schematic diagram showing a comparison of data of radiation efficiency parameters of an antenna of an embodiment of the present disclosure with radiation efficiency parameters of a conventional antenna in the same metal environment.

FIG. 11 is a schematic diagram showing radiant efficiency results graph consistent with the present disclosure.

### DETAILED DESCRIPTION OF THE EMBODIMENTS

The embodiments of this disclosure will now be described with reference to the accompanying drawings. However, it should be understood that these descriptions are exemplary only and are not intended to limit the scope of this disclosure. Furthermore, descriptions of well-known structures and technologies are omitted in the following description to avoid unnecessarily obscuring the concepts of this disclosure.

The terminology used herein is solely for describing particular embodiments and is not intended to limit the scope of this disclosure. The terms “comprising,” “including,” etc., as used herein indicate the presence of said features, steps, operations, and/or components, but do not exclude the presence or addition of one or more other features, steps, operations, or components.

All terms used herein (including technical and scientific terms) have the meanings commonly understood by those skilled in the art, unless otherwise defined. It should be noted that the terms used herein should be interpreted in a manner consistent with the context of this specification and should not be interpreted in an idealized or overly rigid manner.

The accompanying drawings illustrate some block diagrams and/or flowcharts. It should be understood that some blocks or combinations thereof in the block diagrams and/or flowcharts may be implemented by computer program instructions. These computer program instructions can be provided to a processor of a general-purpose computer, a special-purpose computer, or other programmable data processing apparatus, such that, when executed by the processor, these instructions can create means for implementing the functions/operations illustrated in these block diagrams and/or flowcharts.

In the description of this specification, references to the terms “an embodiment,” “some embodiments,” “example,” “specific example,” or “some examples,” etc., indicate that a specific feature, structure, material, or characteristic described in connection with that embodiment or example is included in at least one embodiment or example of this disclosure. Furthermore, the specific features, structures, materials, or characteristics described may be combined in any suitable manner in one or more embodiments or examples. Moreover, those skilled in the art can combine and integrate the different embodiments or examples described in this specification and the features of different embodiments or examples without contradiction.

Furthermore, the terms “first” and “second” are used for descriptive purposes only and should not be construed as indicating or implying relative importance or implicitly specifying the number of indicated technical features. Thus, a feature defined as “first” or “second” may explicitly or implicitly include at least one of that feature. In the description of this disclosure, “a plurality of” means two or more, unless otherwise expressly specified.

Currently, electronic devices can use the shape of the metal frame to design the antenna by grooving on the metal back plate, or by adding plastic parts after grooving a predetermined position in the metal casing to make room for the antenna. These methods require complex processes, increase manufacturing costs, and the slotted portion is inconsistent in color with the original metal casing, disrupting the overall appearance of the electronic device.

Therefore, the disclosure provides an antenna and electronic device to partially solve at least the above problems.

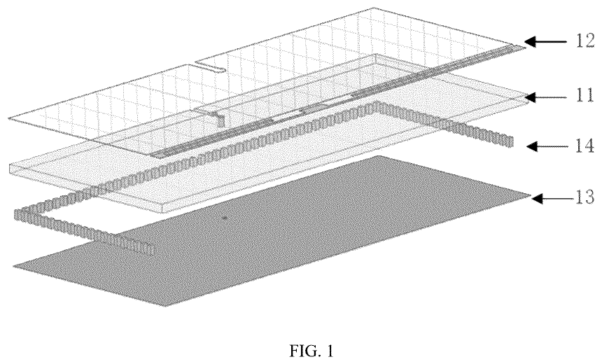

The antenna of the disclosed embodiment will be described in detail below with reference to FIGS. 1 to 8.

FIG. 1 is a schematic exploded structural view of an antenna consistent with the present disclosure.

As shown in FIG. 1, in some embodiments of this disclosure, an antenna 1 includes a dielectric substrate 11, a first conductive plate 12, a second conductive plate 13, and a plurality of metal members 14.

The first conductive plate 12 may be disposed at a first surface of the dielectric substrate 11 (e.g., the upper surface as shown in FIG. 1), and the second conductive plate 13 may be disposed at a second surface of the dielectric substrate 11 (e.g., the lower surface as shown in FIG. 1). The plurality of metal members 14 may be arranged sequentially adjacent to each other in the dielectric substrate 11.

In a plurality of metal members 14, the distance between two adjacent metal members 14 is greater than a preset distance, so that the projection of the overall shape formed by the plurality of metal members 14 onto the dielectric substrate presents an opening 141. For example, in the dielectric substrate 11, the two outermost metal members can be spaced a certain distance apart, while the other metal members 14 can be arranged closely together. It should be noted that the opening is not with respect to a single metal element 14. That is, the opening is not formed at a single metal element 14. Rather, the plurality of metal members 14 are considered as a whole and no metal element 14 is provided at a preset position in the dielectric substrate 11. As a result, the totality of the plurality of metal members 14, when viewed as a whole, has a opening.

Consistent with the present disclosure, when a varying electrical signal is input to the first conductive plate 12 and the second conductive plate 13, a varying electric field is generated.

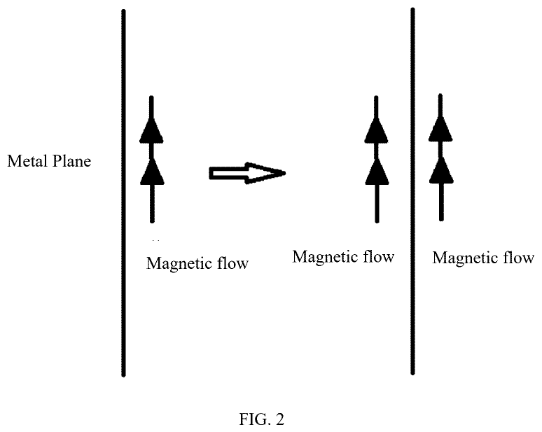

FIG. 2 is a schematic diagram showing principles of electromagnetic mirroring consistent with the present disclosure.

As shown in FIG. 2, electromagnetic mirroring means that the electromagnetic field generated by any charge or current in the space above an infinitely large, ideal conductive plate is electrically equivalent to the field generated by the original charge or current superimposed on the field generated by its mirror. Based on the electromagnetic mirroring principle, when alternating current (e.g., a sinusoidal voltage) is input to the first conductive plate 12 and the second conductive plate 13, a varying electric field is generated between the first conductive plate 12 and the second conductive plate 13. If the electric field changes rapidly enough, the varying electric field can influence the surrounding space, exciting an equivalent magnetic field perpendicular to the electric field for radiation. Since multiple metal members 14 are disposed in the dielectric substrate 11 of the antenna 1, these metal members 14 can influence the radiation direction of the equivalent magnetic field, allowing the magnetic field to radiate out from the opening in a direction parallel to either the first or second conductive plate.

Consistent with the present disclosure, by placing two parallel conductive plates on the upper and lower surface of the dielectric substrate, electromagnetic waves can be generated when a voltage is applied. By utilizing the influence of the metal members on the direction of electromagnetic wave radiation, the electromagnetic waves can be radiated parallel to the pre-reserved openings in the metal casing, thereby reducing the impact of the metal casing environment on the antenna performance.

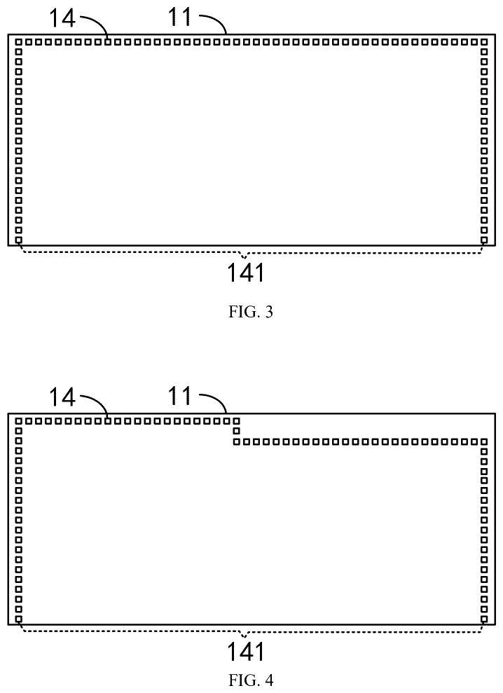

FIG. 3 schematically shows a projected pattern of a plurality of metal members on a dielectric substrate consistent with the present disclosure.

As shown in FIG. 3, based on the above embodiment, in some embodiments, the multiple metal members 14 can be arranged in one or more lines along the edge(s) of the dielectric substrate 11.

For example, the shape of the dielectric substrate 11 can be a rectangle, then multiple metal members 14 can be arranged closely along three adjacent sides of the rectangle edge, with no metal members 14 on the fourth side. This fourth side can then serve as a radiating side (opening 141) to radiate electromagnetic waves. The shape of the dielectric substrate 11 described above is merely an example to illustrate the arrangement of multiple metal members 14 and is not intended to limit the antenna shape of this disclosure. The specific shape of the antenna can be designed according to the actual application scenario.

Consistent with the present disclosure, when a varying electrical signal is input to the first conductive plate 12 and the second conductive plate 13, a magnetic field can be formed in the area between the first conductive plate 12 and the second conductive plate 13. Multiple metal members 14 can be disposed at the edge of the dielectric substrate 11 to change the direction of the magnetic field in a larger area between the first conductive plate 12 and the second conductive plate 13, causing it to radiate out from the opening 141, thereby improving the antenna's radiation performance.

For details of the antenna, reference can be made to the description in the foregoing embodiments.

FIG. 4 schematically shows another projected pattern of a plurality of metal members on a dielectric substrate consistent with the present disclosure.

As shown in FIG. 4, based on the above disclosure, in some embodiments, multiple metal members 14 can be arranged in one or more lines. Among the multiple metal members 14, the lines formed by connecting the metal members 14 opposite to the side where the opening 141 is located present a stepped shape.

For example, the shape of the dielectric substrate 11 can be a rectangle, the multiple metal members 14 can be closely arranged along three adjacent sides of the rectangle edge, with no metal members 14 on the fourth side. This allows the fourth side to act as a radiating side, radiating electromagnetic waves. The multiple metal members on the side opposite to the fourth side are not all arranged along the edge, and they can be arranged in a stepped shape.

Consistent with the present disclosure, on the side opposite to the radiating side, the lines formed by the multiple metal members are far from the radiating side, corresponding to the radiation of low-frequency electromagnetic waves; the lines formed by the multiple metal members are close to the radiating side, corresponding to the radiation of high-frequency electromagnetic waves. Through the arrangement of the metal members, the antenna can simultaneously radiate both high-frequency and low-frequency electromagnetic waves, expanding the antenna's applicability.

FIG. 5 schematically shows another projected pattern of a plurality of metal members on a dielectric substrate consistent with the present disclosure.

As shown in FIG. 5, based on the above disclosure, in some embodiments, the lines formed by connecting multiple metal members opposite to the edge where the opening is located are arranged in a stepped manner to radiate multiple electromagnetic waves of different frequencies.

For example, the shape of the dielectric substrate 11 can be a rectangle, then multiple metal members 14 can be closely arranged along three adjacent sides of the rectangle edge, with no metal member 14 on the fourth side. Thus, the fourth side can serve as a radiating edge to radiate electromagnetic waves. The multiple metal members on the side opposite to the fourth side are not all arranged along the edge, and they can be arranged in a stepped pattern. The number of steps can be 2, 3, 4, etc. The multiple metal members can be arranged according to the actual application scenario.

Consistent with the present disclosure, multiple metal members 14 are arranged in a stepped pattern on the edge opposite to the radiating edge. Each step corresponds to a plurality of metal members 14 that can radiate electromagnetic waves of one frequency. Therefore, the plurality of metal members 14 arranged in multiple steps can radiate electromagnetic waves of multiple frequencies, resulting in a wider coverage of the antenna's radiation frequency range.

Based on the above disclosure, in some embodiments, the multiple metal members are arranged in one or more lines. The lines formed by connecting the multiple metal members include at least one of straight lines or curves.

For example, taking the arrangement of the multiple metal members 14 shown in FIGS. 3-5 as an example, the lines formed by connecting the multiple metal members 14 include straight lines.

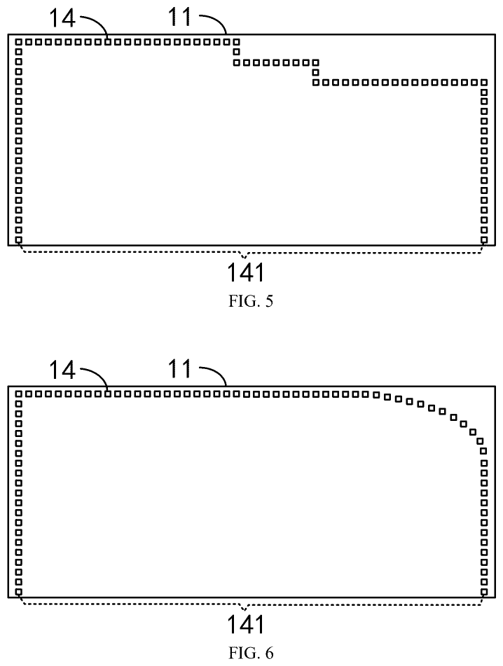

FIG. 6 schematically shows another projected pattern of a plurality of metal members on a dielectric substrate consistent with the present disclosure.

As shown in FIG. 6, for example, the lines formed by connecting the multiple metal members 14 include both straight lines and curves.

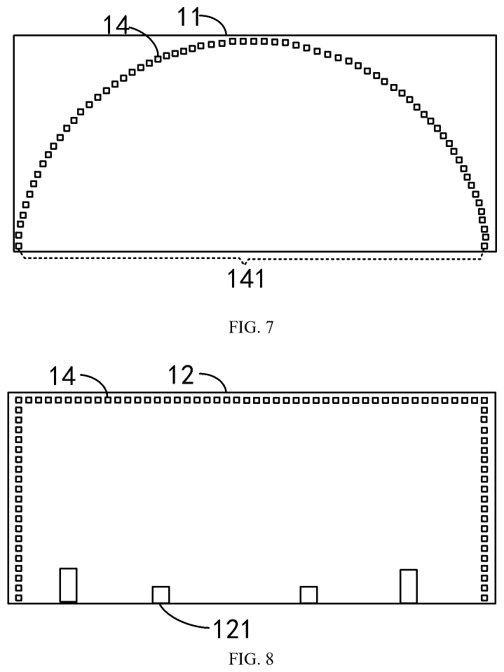

FIG. 7 schematically shows another projected pattern of a plurality of metal members on a dielectric substrate consistent with the present disclosure.

As shown in FIG. 7, for example, the lines formed by connecting multiple metal members 14 include curves.

Consistent with the present disclosure, the radiation frequency of the antenna can be flexibly adjusted by designing the shape of the lines arranged with multiple metal members.

Based on the above disclosure, multiple vias are formed along a direction perpendicular to the first surface, penetrating the first conductive plate, the dielectric substrate, and the second conductive plate. The internal surfaces of the multiple vias are formed with metal, constituting multiple metal members.

Consistent with the present disclosure, since vias may need to be fabricated in the first conductive plate 12, the dielectric substrate 11, and the second conductive plate 13 to connect printed conductors between layers, metal layers are directly plated in the vias to form metal members 14, thereby changing the radiation direction of electromagnetic waves. This eliminates the need for additional metal members in other areas, simplifying the manufacturing process.

FIG. 8 is a schematic external structural view of an antenna consistent with the present disclosure.

As shown in FIG. 8, based on the above disclosure, at least one groove is further formed at the first conductive plate or the second conductive plate. The groove is used to adjust the frequency of the radiated electromagnetic waves.

For example, a groove can be provided at the first conductive plate at the edge where the opening 141 is located. After the antenna is manufactured, the antenna can be adjusted based on the groove 121.

Consistent with the present disclosure, since at least one groove is further formed at the first conductive plate or the second conductive plate, even after the antenna is manufactured, the frequency of the radiated electromagnetic waves can be adjusted based on the groove to meet different application needs of electronic devices.

Based on the above disclosure, the dielectric substrate includes a printed circuit board (PCB), the first conductive plate includes a metal plate, and the second conductive plate includes a metal plate.

Consistent with the present disclosure, the dielectric substrate 12 of the antenna is a PCB, and the antenna can be a PCB antenna. The material of the metal plate can be, for example, copper.

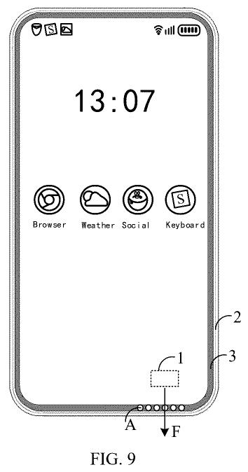

The embodiments of present disclosure also provide an electronic device. The electronic device of the disclosed embodiments will be described in detail below with reference to FIG. 9.

FIG. 9 is a schematic structural diagram of an electronic device consistent with the present disclosure.

As shown in FIG. 9, the electronic device includes an antenna 1, a metal back cover 2, and a metal backplate 3 of a screen. The antenna 1 is disposed between the metal back cover 2 and the metal backplate 3 of the screen.

The antenna 1 includes a dielectric substrate 11, a first conductive plate 12 disposed at a first surface of the dielectric substrate, and a second conductive plate 13 disposed at a second surface of the dielectric substrate, with the first surface being opposite to second surface.

A plurality of metal members 14 are arranged sequentially and adjacently at the dielectric substrate 11. The distance between two adjacent metal members 14 is greater than a preset distance, such that the projection of the overall shape formed by the plurality of metal members 14 projects onto the dielectric substrate 11 with presents an opening 141. The direction of the opening 141 is parallel to either the first surface or second surface. When a varying electrical signal is input to the first conductive plate and second conductive plate, a varying electric field is generated, which in turn generates a varying magnetic field, radiating from the opening 141.

In some embodiments, the direction F of the opening 141 points towards the screen frame, the acoustic cavity slot (e.g., area A in FIG. 9), or the air vent window of the electronic device.

The electronic device in FIG. 9 includes, for example, a mobile phone, a laptop computer, a tablet computer, a wearable device, etc.

An antenna with the structure consistent with the present disclosure is applied to an electronic device. By placing two parallel conductive plates on the upper and lower surface surfaces of a dielectric substrate, electromagnetic waves can be generated when a voltage is applied. The influence of the metal members on the direction of electromagnetic wave radiation allows the electromagnetic waves to radiate parallel to the metal casing. This radiation method can reuse spaces such as screen frames, speaker cavity slots, and air vents for radiation, reducing manufacturing costs.

Based on the above disclosure, in some embodiments, the antenna 1 is fixed between the metal back cover 2 and the metal back plate 3 of the screen using a fastener, so that the antenna 1 does not contact the metal back cover 2 or the metal back plate 3 of the screen.

This arrangement is to address the issue that contact between the antenna 1 and the metal back cover 2 or the metal back plate 3 of the screen would significantly reduce the radiation performance of the antenna 1. Therefore, fixing the antenna 1 between the metal back cover 2 and the metal back plate 3 of the screen using a fastener avoids contact with the metal back cover 2 and the metal back plate 3 of the screen, thus preventing a reduction in the radiation performance of the antenna 1. In some embodiments, the antenna can be fixed between the keyboard and the metal back cover using a fastener.

The fastener can be determined according to actual needs. For example, the fixing component can be a clip. Fixing the antenna 1 between the metal back cover 2 and the metal back plate 3 of the screen using a fastener can include fixing the antenna 1 between the metal back cover 2 and the metal back plate 3 of the screen using a clip, ensuring that the antenna 1 does not contact the metal back cover 2 or the metal back plate 3 of the screen, thus preventing a significant reduction in antenna radiation performance.

In some embodiments, the antenna 1 is disposed between the metal back cover 2 and the metal back plate 3 of the screen using an insulation member, so that the antenna 1 does not contact the metal back cover 2 or the metal back plate 3 of the screen.

This arrangement is due to the consideration that contact between the antenna 1 and the metal back cover 2 or the metal back plate 3 of the screen would greatly reduce the radiation performance of the antenna 1. Therefore, fixing the antenna 1 between the metal back cover 2 and the metal back plate 3 of the screen using an insulation member, ensuring that the antenna 1 does not contact the metal back cover 2 or the metal back plate 3 of the screen, thus preventing a reduction in the radiation performance of the antenna 1.

The insulation member can be determined according to the actual situation. For example, the insulation member can be a gasket made of metallic and non-metallic materials, such as a spiral wound gasket or a metal-coated gasket. Fixing the antenna 1 between the metal back cover 2 and the metal back plate 3 of the screen using an insulation member can be fixing the antenna 1 between the metal back cover 2 and the metal back plate 3 of the screen using a wound gasket or a metal-clad gasket, ensuring that the antenna 1 does not contact with the metal back cover 2 and the metal back plate 3 of the screen, thereby preventing a significant reduction in antenna radiation performance.

For details, reference can be made to the description of the antenna above.

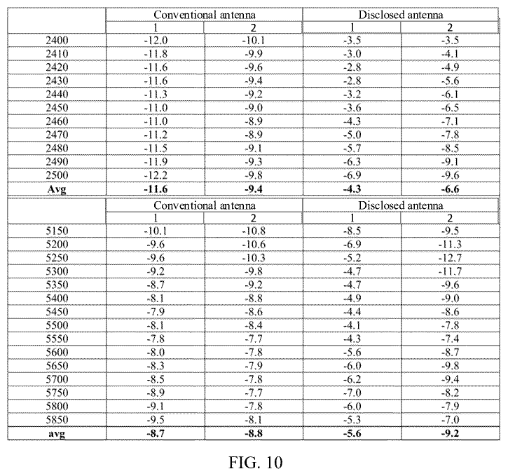

FIG. 10 schematically shows a comparison of data of radiation efficiency parameters of an antenna of an embodiment of the present disclosure with radiation efficiency parameters of a conventional antenna in the same metal environment.

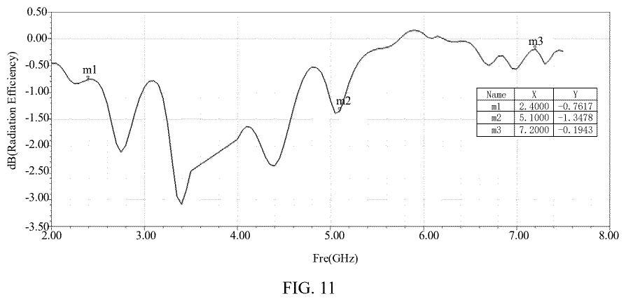

FIG. 11 schematically shows radiant efficiency results graph consistent with the present disclosure.

As shown in FIGS. 10 and 11, compared with a conventional antenna, the antenna provided by the embodiments of the present disclosure has higher radiation efficiency and a wider radiation frequency range.

Those skilled in the art will understand that the features recited in the various embodiments and/or claims of this disclosure can be combined or integrated in various ways, even if such combinations or integrations are not explicitly stated in this disclosure. In particular, the features recited in the various embodiments and/or claims of this disclosure can be combined or integrated in various ways without departing from the spirit and teachings of this disclosure. All such combinations and/or integrations fall within the scope of this disclosure.

The embodiments of this disclosure have been described above. However, these embodiments are for illustrative purposes only and are not intended to limit the scope of this disclosure. Although various embodiments have been described above, this does not mean that the measures in the various embodiments cannot be used advantageously in combination. The scope of the invention is defined by the appended claims and their equivalents. Various substitutions and modifications can be made by those skilled in the art without departing from the scope of this disclosure, and all such substitutions and modifications should fall within the scope of this disclosure.

What is claimed is:

1. An antenna comprising:
a dielectric substrate having a first surface and a second surface opposite to each other;
a first conductive plate arranged at the first surface;
a second conductive plate arranged at the second surface; and
a plurality of metal members sequentially arranged adjacently one after another at the dielectric substrate, a distance between two adjacent metal members among the plurality of metal members being greater than a preset distance, and a projection of an overall shape of the plurality of metal members on the dielectric substrate having an opening.

2. The antenna according to claim 1, wherein the plurality of metal members are arranged in one or more lines along one or more edges of the dielectric substrate.

3. The antenna according to claim 2, wherein a line formed by connecting two or more metal members, of the plurality of metal members, opposite to an edge where the opening is located presents a stepped shape.

4. The antenna according to claim 3, wherein the line formed by connecting the two or more metal members has a plurality of steps and the two or more metal members are configured to radiate electromagnetic waves at a plurality of different frequencies.

5. The antenna according to claim 2, wherein each of the one or more lines is a straight line or a curved line.

6. The antenna according to claim 1, wherein a plurality of vias penetrating the first conductive plate, the dielectric substrate, and the second conductive plate are formed in a direction perpendicular to the first surface, and the plurality of metal members are formed at inner surfaces of the plurality of vias.

7. The antenna according to claim 1, wherein at least one groove is formed at the first conductive plate or the second conductive plate, and the at least one groove is configured to adjust a frequency of an electromagnetic wave radiated by the antenna.

8. The antenna according to claim 1, wherein the dielectric substrate includes a printed circuit board, the first conductive plate includes a first metal plate, and the second conductive plate includes a second metal plate.

9. An electronic device comprising:
a metal back cover;
a metal back plate of a screen; and
an antenna disposed between the metal back cover and the metal back plate of the screen, and including:
a dielectric substrate having a first surface and a second surface opposite to each other;
a first conductive plate arranged at the first surface;
a second conductive plate arranged at the second surface; and
a plurality of metal members sequentially arranged adjacently one after another at the dielectric substrate, a distance between two adjacent metal members among the plurality of metal members being greater than a preset distance, and a projection of an overall shape of the plurality of metal members on the dielectric substrate having an opening.

10. The electronic device according to claim 9, wherein the antenna is fixed between the metal back cover and the metal back plate of the screen through a fastener, and the antenna is not in contact with the metal back cover and the metal back plate.

11. The electronic device according to claim 9, wherein the antenna is fixed between the metal back cover and the metal back plate of the screen through an insulation member, and the antenna is not in contact with the metal back cover and the metal back plate.

12. The electronic device according to claim 9, wherein the plurality of metal members are arranged in one or more lines along one or more edges of the dielectric substrate.

13. The electronic device according to claim 12, wherein a line formed by connecting two or more metal members, of the plurality of metal members, opposite to an edge where the opening is located presents a stepped shape.

14. The electronic device according to claim 13, wherein the line formed by connecting the two or more metal members has a plurality of steps and the two or more metal members are configured to radiate electromagnetic waves at a plurality of different frequencies.

15. The electronic device according to claim 12, wherein each of the one or more lines is a straight line or a curved line.

16. The electronic device according to claim 9, wherein a plurality of vias penetrating the first conductive plate, the dielectric substrate, and the second conductive plate are formed in a direction perpendicular to the first surface, and the plurality of metal members are formed at inner surfaces of the plurality of vias.

17. The electronic device according to claim 9, wherein at least one groove is formed at the first conductive plate or the second conductive plate, and the at least one groove is configured to adjust a frequency of an electromagnetic wave radiated by the antenna.

18. The electronic device according to claim 9, wherein the dielectric substrate includes a printed circuit board, the first conductive plate includes a first metal plate, and the second conductive plate includes a second metal plate.
